(19) United States
(12) Patent Application Publication
(10) Pub. No.: US 2017/0337319 A1
(43) Pub. Date: Nov. 23, 2017

(54) System and Method for Optimization of Digital Circuits with Timing and Behavior Co-Designed by Introduction and Exploitation of False Paths

(71) Applicant: Ecole Polytechnique Fédérale de Lausanne (EPFL), Lausanne (CH)

(72) Inventors: Vincent Camus, Neuchâtel (CH); Jérémy Schlachter, Montagny-près-Yverdon (CH); Christian Enz, St-Aubin (CH)

(21) Appl. No.: 15/159,836

(22) Filed: May 20, 2016

(51) Int. Cl. G06F 17/50

(52) U.S. Cl. CPC G06F 17/5081; G06F 2217/78; G06F 2217/84

(57) ABSTRACT

A digital circuit including a signal path with a false path, whereby the signal path includes at least 3 logic instances, the digital circuit further including a logic monitoring element for monitoring a part of the digital circuit, and for outputting a cut-back signal in case a determined risk of a full activation of the signal path is detected in the monitoring, wherein the signal path includes a logic cutting selector element as one of the 3 logic instances, the logic cutting selector element to be triggered by at least the cut-back signal to prevent the full activation of the signal path, the logic cutting selector element being configured to switch, the switching either maintaining the signal path itself, or preventing the full activation of the signal path by substituting it for an alternate signal path, thereby inducing the false path.

### TECHNICAL FIELD

The present invention relates to systems and methods for optimizing the design of digital circuits to improve speed capabilities and energy consumption, and digital circuits optimized by the system and method.

### BACKGROUND

Density, speed and energy efficiency of digital circuits have been increasing exponentially for the last four decades following Moore's law. However, power and reliability pose several challenges to the future of technology scaling. Power has definitely emerged as a critical concern due to the poor scaling of the operating supply voltage and transistor threshold voltage, while transistor miniaturization reaching atomic scale has led to tremendous Process-Voltage-Temperature (PVT) variations. Unfortunately, achieving low-power and robustness against variability requires complex and conflicting design constraints. As a result, designers are being pushed to seek new techniques for energy-efficient circuits and computing to meet the increasing demand of data processing.

### SUMMARY

According to one aspect of the present invention, a digital circuit is provided, having a signal path with a false path, whereby the signal path includes at least 3 logic instances. Moreover, preferably, the digital circuit further includes a logic monitoring element configured to monitor a part of the digital circuit, and to output a cut-back signal in case a determined risk of a full activation of the signal path is detected in the monitoring, and preferably the signal path includes a logic cutting selector element as one of the three logic instances, the logic cutting selector element being configured to be triggered by at least the cut-back signal to prevent the full activation of the signal path, the logic cutting selector element being configured to switch, the switching either maintaining the signal path itself, or preventing the full activation of the signal path by substituting it for an alternate signal path, thereby inducing the false path.

According to another aspect of the present invention, a method for optimizing a digital circuit, is provided. The method preferably includes a step of transforming a digital circuit to improve a digital circuit implementation, by transforming at least one signal path of the digital circuit into a false path, for co-designing the digital circuit behavior and the digital circuit implementation.

According to yet another aspect of the present invention, a non-transitory computer readable medium is provided, the computer readable medium having computer readable instruction code recorded thereon, the instruction code configured to perform a method when executed on a hardware computer. In addition, preferably the method includes a step of transforming a digital circuit to improve a digital circuit implementation, by transforming at least one signal path of the digital circuit into a false path, for co-designing the digital circuit behavior and the digital circuit implementation.

The above and other objects, features and advantages of the present invention and the manner of realizing them will become more apparent, and the invention itself will best be understood from a study of the following description with reference to the attached drawings showing some preferred embodiments of the invention.

### BRIEF DESCRIPTION OF THE SEVERAL VIEWS OF THE DRAWINGS

The accompanying drawings, which are incorporated herein and constitute part of this specification, illustrate the presently preferred embodiments of the invention, and together with the general description given above and the detailed description given below, serve to explain features of the invention.

FIGS. 1A-1C are circuit block diagrams illustrating examples of implementation of the method or technique, according to one aspect of the present invention;

FIG. 2A is a circuit block diagram illustrating an exemplary use of the method on the carry-chain of an adder circuit;

FIG. 2B is a synthetic circuit block diagram illustrating the exemplary use of the method of FIG. 2A;

FIGS. 2C-2D are synthetic circuit block diagrams illustrating an exemplary use of the method on the carry-chain of an adder circuit;

FIGS. 3A-3D are synthetic circuit block diagrams illustrating an exemplary use of the method on several signal paths of an arithmetic circuit;

FIGS. 4A-4B are block diagrams of the exemplary use of the method in the proposed Carry Cut-Back approximate adder;

FIG. 5 is an explanatory diagram illustrating the longest effective carry propagation chains in an example of implementation of the proposed Carry Cut-Back approximate adder;

FIGS. 6A-6B are diagrams illustrating the addition arithmetic of an exemplary implementation of the proposed Carry Cut-Back approximate adder with an exemplary computation;

FIGS. 7A-7B are diagrams illustrating balanced and unbalanced binary error patterns;

FIGS. 8A-8B are diagrams illustrating an example of worst-case relative error in an operation in the exemplary implementations of FIGS. 6A-6B;

FIGS. 9A-9B are diagrams illustrating the relative errors and normalized implementation costs in terms of power-delay-area product and energy of representative examples of 32-bit implementations of the proposed Carry Cut-Back approximate adder compared to the exact adder implementation, obtained after synthesis at 3.3 GHz and 800 MHz in a 65 nm standard CMOS process;

FIGS. 10A-10C are circuit block diagrams illustrating an example of application of the method from the circuit and signal path illustrated in FIG. 10A;

FIG. 11 is a flowchart illustrating an exemplary method according to another aspect of the present invention for optimizing a circuit using;

FIGS. 12A-12D are synthetic circuit block diagrams illustrating exemplary states of the circuit at different successive process steps of an exemplary software-implemented method for optimizing a digital circuit using the disclosed method; and

TABLES 1A-1B illustrate the implementation costs in terms of energy, area and normalized power-delay-area product of representative examples of 32-bit implementations of the proposed Carry Cut-Back approximate adder compared with the exact adder implementation and representative implementations of state-of-the-art approximate adders, obtained after synthesis at 3.3 GHz and 800 MHz in a 65 nm standard CMOS process.

### DETAILED DESCRIPTION OF THE SEVERAL EMBODIMENTS

Herein representative embodiments of the circuits, methods of insertion and exploitation of false paths in signal paths of digital circuits are described. The disclosed circuits and methods should not be construed as limiting in any way. The present disclosure is directed toward novel and nonobvious features and aspects of the various disclosed embodiments, alone and in various combinations with one another. The disclosed circuits and methods may be implemented by means of scripts and computer-implemented software, software or other computer executable code stored on a non-transitory computer-readable medium, or made available from a list of codes and files comprising or executing fully or partially some of the disclosed embodiments, including but not limited to optimization libraries, arithmetic component libraries, building block libraries, IP blocks or cores, hardware and/or software macros.

According to one aspect of the present invention, a general circuit technique or method is provided. Embodiments of the present invention include a digital circuit device comprising a signal path with a false path, whereby a logic monitoring element in the digital circuit is configured to monitor a part of the digital circuit, and to output a cut-back signal in case a determined risk of a full activation of the signal path is detected in the monitoring, and wherein the signal path comprises a logic cutting selector element configured to be triggered by at least the cut-back signal to switch, the switching either maintains the signal path itself, or prevents the full activation of the signal path by substituting it for an alternate signal path, thereby inducing the false path.

Preventing the full activation of a signal path in the digital circuit by inducing a false path with the disclosed invention allows to relax the timing constraints that can result in lower design cost, higher yield, or earlier arrival times of signal paths. In some cases, if a signal path fails to fit the delay constraint, the use of the disclosed technique can make it possible to fit the delay constraint. The disclosed invention can also be used to improve delay safety margins on a signal path, improving the robustness of its output against PVT variations.

The circuits described herein can be integrated in many technologies, including but not limited to Application-Specific Integrated Circuits (ASICs), Programmable Logic Devices (PLDs) or Field-Programmable Gate Arrays (FPGAs). In the case of FPGAs, the disclosed technique can be particularly interesting in order to overcome their hardware limitations, interconnect constraints and limited operational speed.

In some embodiments, the logic cutting element is triggered by at least the cut-back signal outputted from the logic monitoring element when the logic monitoring element detects a determined risk of full activation of the signal path. In the disclosed invention, the logic cutting element is configured to switch between at least the signal path and an alternate signal path. The logic cutting element may comprise a multiplexor or a logic gate to switch between the signal path and the alternate signal path.

The logic cutting element is not limited to combinational logic, it may utilize pre-computed or stored signals and values for the logic cutting or for the alternate signal path. The logic cutting element can also be a straight cut of the signal path, the alternate path is thus reduced to setting a static value (logic 0 or logic 1), or a determined or stored dynamic value, in those cases the logic cutting element can comprise at least a logic gate or a storage element. For those reasons, and for leaving full optimizations of the circuits to circuit synthesis tools, the cut-back signal can be both an active-low or active-high trigger.

The alternate signal path can be smaller or faster than the original signal path. This is often the case at design time, before timing analysis and layout generation, but as the synthesis tools generally optimize the timing of all the circuit paths to fit a determined timing constraint, the signal path and the alternate signal path might have similar delays. Nevertheless, the use of the disclosed technique would have benefit to the circuit by relaxing the constraints on the signal path.

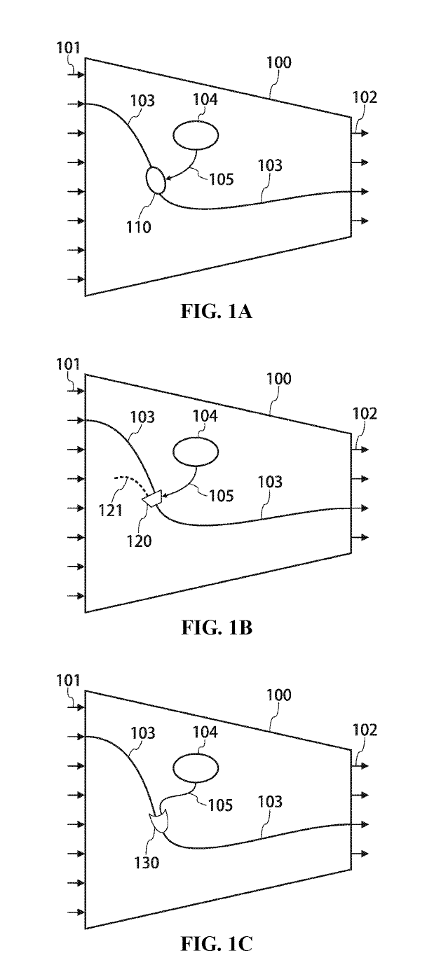

FIGS. 1A-1C are circuit block diagrams illustrating exemplary implementations of the disclosed technique or method. The digital circuit 100 has at least one input 101 and at least one output 102. FIGS. 1A-1C show an example of implementation of the technique on the signal path 103 with the logic monitoring element 104 that triggers the logic cutting element with at least the cut-back signal 105. FIG. 1A shows a general implementation of the logic cutting element 110. FIG. 1B shows an exemplary implementation of the logic cutting element comprising a multiplexer 120 and an alternate signal path 121 pictured as a dashed line. FIG. 1C shows an exemplary implementation of the logic cutting element comprising a logic element 130.

In some embodiments, the logic monitoring element is configured to monitor a part of the digital circuit, and to output a cut-back signal in case a determined risk of the full activation of the signal path is detected in the monitoring, the cut-back signal triggers the logic cutting element to prevent the full activation of the signal path.

The mentioned determined risk of the full activation of the signal path that can be determined in accordance with the additional delay and cost of hardware implementation of the logic monitoring element, with possible consideration of existing hardware, it should not be construed as limiting in any way. The determined risk of the full activation of the signal path might be overestimated. For instance, monitoring of a single carry stage of a 32-bit adder will output a cut-back signal that triggers the logic cutting element with a probability of 0.5, corresponding to the case for which the carry stage is in propagate mode, despite the full activation of the entire adder carry-chain happens only when all the stages are in propagate modes, which happens with an extremely low probability. The determined risk of the full activation of the signal path might be under-estimated because of the designer's choice, or because the signal path might naturally be a false path due to other logic combinations. For example, this could be the case if an adder circuit is used as a counter for which the computations that lead to the full activation of the carry chain are never executed.

In some embodiments, the logic monitoring element may comprise but not be limited to combinational logic elements, it may utilize pre-computed or stored signals and values, thus it may comprise at least a logic gate or a storage element.

In some embodiments, the logic monitoring element is configured to monitor at least one signal of higher significance than the signal at a position of the logic cutting selector element in the signal path. This method, called the cut-back technique, can minimize the alteration of the digital circuit behavior. The logic monitoring element can monitor signals resulting from various computations that can guarantee no or low impact of the behavioral alteration induced by triggering the logic cutting element to select the alternate signal path. The alteration of the digital circuit behavior with the logic cutting element can also be made acceptable for the digital circuit specifications or tolerated by the designer's choice thanks to a logic monitoring of higher-significance signals that guarantee the low relative impact of the logic cutting with occurrence of specific combinations of monitored signals. As an exemplary embodiment, applying the disclosed technique on the carry chain of an adder circuit, the logic monitoring of a high-significance carry stage of the carry chain and the logic cutting of the carry chain at a lower-significance position can ensure that the behavior alteration due to the logic cutting has low impact on the overall result of an unsigned addition, this example is explained in details afterwards. When the digital circuit is fully or partially used for an arithmetic computation, for instance in an arithmetic operator or in the data path of a codec, a hardware accelerator or a Floating-Point Unit (FPU) circuit, embodiments of the present invention allow the computation to be executed with a reduced binary precision when the alternate signal path is selected by the logic cutting selector, compared to when the signal path is selected.

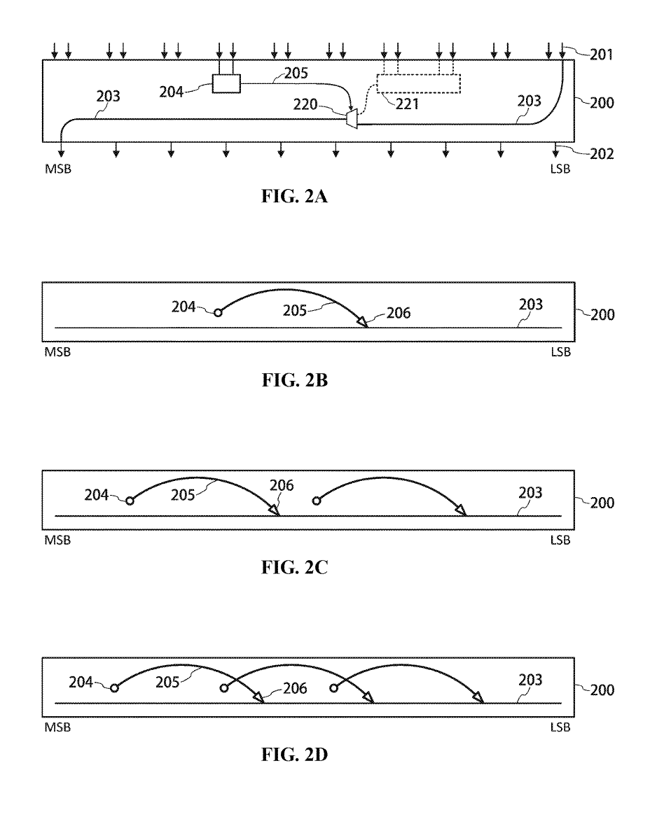

FIG. 2A is a circuit block diagram illustrating an exemplary use of the disclosed technique in an adder circuit. In the adder circuit 200 comprising at least one input 201 and at least one output 202 sorted by significance from the LSB (on the right) to the MSB (on the left), the signal path 203 is the carry chain of the adder on which the technique is applied. An example of logic monitoring element 204 monitors two input signals and outputs the cut-back signal 205 that triggers the logic cutting of the signal path 203 when it detects a configuration of its inputs that allows a full activation of the signal path 203. The logic cutting elements comprises a multiplexor 220 configured to switch between the signal path 203 and an alternate signal path 221 pictured with dashed lines. In the illustrated example, the alternate signal path is configured to use four input signals at relatively lower significance than the logic monitoring elements 204. Also, the alternate signal path 221 is configured to speculate the carry signal at the position of the multiplexer 220, as it uses less inputs than the carry chain that goes up to the LSB, it can be faster to compute than the carry chain.

In one embodiment, it is possible to use a plurality of logic cutting on one signal path. In other embodiments, the different elements of the invention can be combined and shared partially or fully in the cases of multiple logic monitoring elements, logic cutting elements, cut-back signals and alternate paths. For instance, one logic monitoring element can trigger a plurality of logic cutting elements, possibly on a plurality of signal paths, this is particularly interesting to limit the logic monitoring hardware overhead. In another exemplary embodiment, one logic cutting element can substitute the signal path with a plurality of alternate paths.

To simplify the illustrations, FIGS. 2B-2D are synthetic representations of an adder circuit block diagram. In these synthetic representations, the logic monitoring element 204 triggers, with the cut-back signal 205, the logic cutting element 206 to prevent activation of the signal path 203 when detecting a risk of full activation in the logic monitoring. FIG. 2B illustrates the same exemplary adder implementation as in FIG. 2A. FIGS. 2B-2D illustrate different exemplary adder implementations, with multiple cuts on the same signal path 203, possibly overlapping each other as in FIG. 2D.

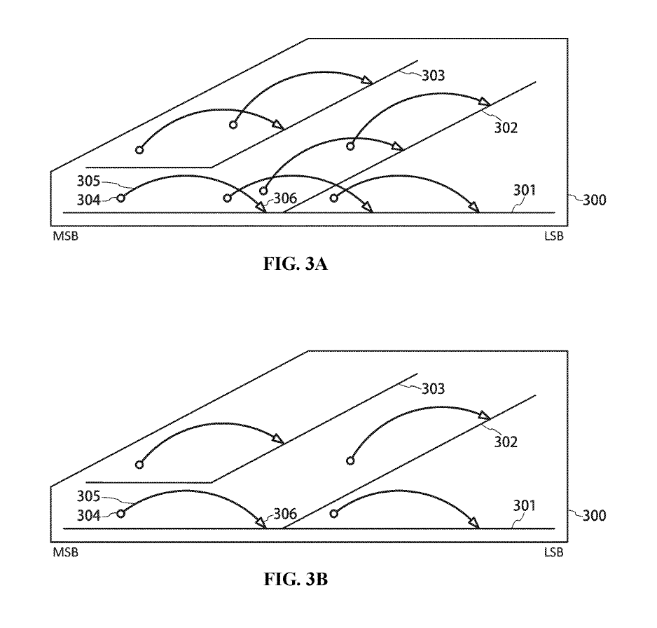

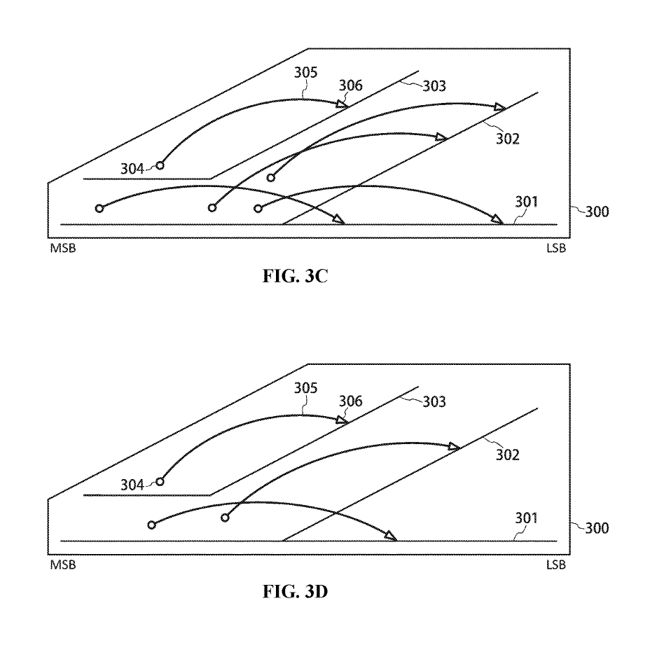

FIGS. 3A-3D are synthetic representations of an arithmetic circuit block diagram illustrating exemplary multiple use of the disclosed technique in a general circuit. In the general circuit 300, the disclosed technique is applied multiple times on multiple signal paths 301, 302 and 303. Note that 301 and 302 are reconvergent paths, i.e. two signal paths that join and lead to the same output signal, those signal paths often exist in parallel architectures of arithmetic circuits. The described technique can be used on many kinds of signal paths, including but not limited to reconvergent paths. In the synthetic representations of FIGS. 3A-3D, the logic monitoring element 304 triggers, with the cut-back signal 305, the logic cutting element 306 to prevent activation of the signal path when detecting a risk of full activation in the logic monitoring. FIG. 3A illustrates exemplary multiple use of the disclosed cut-back technique in the digital circuit 300. The signal path 301 and 302 both contain three cuts, among which one cut is shared on their reconvergent part of signal path, and the signal path 303 contains two cuts. FIG. 3B illustrates a circuit with fewer cuts than in FIG. 3A, the signal path 301 and 302 both contain 2 cuts among which one is shared on their reconvergent part of signal path, while the signal path 303 contains one cut. FIG. 3C illustrates a circuit with longer cuts than in FIG. 3A and FIG. 3D illustrates a circuit with fewer and longer cuts than in FIG. 3A. Longer or fewer cuts can lead to higher computation accuracy.

The digital circuit using the disclosed invention can further be made reconfigurable and adaptive. In an exemplary embodiment, an enabling signal or logic element can be configured to enable or disable the logic monitoring, the logic cut or the alternative path. In another exemplary embodiment, the enabling of the aforementioned elements can be adapted to the digital circuit operative conditions or requirements, based for example on delay or precision conditions. For instance, the logic monitoring element or the logic cutting element can be enabled when the digital circuit must operate at a certain speed, and disabled when it can operate at a lower speed. The different elements of the invention can be programmable in order to modify their behavior in many ways, comprising but not be limited to modifying the logic monitoring's determined risk sensibility, the alternate signal path or the choice of alternate path in the case of a plurality of alternate paths, or the way of combining of a plurality of elements in the case a plurality of elements are combined.

Not illustrated for the sake of simplicity, some embodiments of the disclosed circuit technique comprise multiple false paths inducing reciprocate behavior alterations. The term “reciprocate alterations” may refer to signal path alterations which cause behavioral or accuracy alterations to the circuit that partially or fully cancel out each other. In one exemplary embodiment, one logic monitoring element may trigger multiple logic cutting elements so that the behavior alterations have identical occurrences. In another exemplary embodiment, multiple logic cutting elements may induce opposite or inverse alterations to the circuit behavior. In an interesting example, multiple logic cutting elements inducing reciprocate or canceling-out behavioral alterations when their alternate signal paths are selected can be triggered by a single logic monitoring element, allowing circuit timing relaxation with low or no behavioral alteration compared to when the signal paths are selected by the logic cutting selector. In another embodiment, a storage element may be used in the logic monitoring or logic cutting elements in order to reciprocate the behavioral alteration.

In some embodiments, the disclosed invention can be used in the circuit of a Floating-Point Unit (FPU). The FPU is one of the most common arithmetic blocks of processors or Digital Signal Processors (DSP). Because of its arithmetic complexity, it generally has a costly circuit implementation in terms of power consumption, delay and area. The use of the disclosed technique in an FPU circuit is thus particularly interesting.

As an exemplary embodiment, the disclosed invention can be used in the mantissa calculation of an FPU circuit, comprising but not limited to additions, multiplications, Multiply-Accumulate (MAC) or Fused Multiply-Add (FMA) operations. Due to the use of the floating-point format, the FPU mantissa computation requires large fixed-point arithmetic operations but only collects a limited number of signals for its output. For example, in the IEEE 754 standard, the addition, multiplication and FMA mantissa operations output 28, 48 and 72 bits, respectively, while in the end, the single-precision floating-point format only stores 23 bits. Such bit-widths generally strongly constrain the design, increasing the area and power consumption or limiting the speed of the overall system. In one embodiment of the disclosed invention, insertion of the technique by logically monitoring high-significance signals in the mantissa computation, and by logically cutting at least one of the signal paths of the mantissa computation, it is possible to relax the timing constraint or design cost of the mantissa computation circuit with minimal impact on the overall precision of the FPU. As the FPU precision is already limited by the rounding error, it is also possible to realize an FPU with no degradation of the precision by using features of the present invention with logic cutting and alternate path inducing arithmetic errors of value lower than or equal to the rounding error.

According to one aspect of the present invention, it is possible to use this technique or method as an approximate adder circuits. Approximate computing has emerged as a promising candidate to improve performance and energy efficiency and sustain technology scaling. Designing approximate circuits explores a new trade-off, not only by accepting unreliability, but by intentionally introducing controlled and harmless errors to overcome limitations of traditional circuit design.

To design approximate circuits, several approaches have been investigated at different levels of hardware design, such as voltage-frequency over-scaling at physical level, gate-level pruning at circuit level, or significance-based memory protection at algorithmic level. Another way consists in redesigning the architecture of digital circuits into an approximate version with smaller delay, area or power consumption. This technique is particularly suited for arithmetic computations, such as additions and multiplications.

Adders are the most common arithmetic blocks used in DSPs, thus many attempts have been made to build them in an approximate manner. At architectural level, an interesting way to build approximate adders is to use carry speculation. This technique exploits the fact that carry propagate sequences in additions are typically short, making it possible to estimate, more or less accurately, an intermediate carry using a limited number of previous stages. Thus, the carry chain, critical path of the circuit, can be split into two or more shorter paths, relaxing the constraints over the entire design and pushing energy, delay and area beyond the limits imposed by traditional design.

A number of speculative adders have been proposed in literature based on the Type II Error Tolerant Adder (ETAII) concept. It consists in slicing the addition into regular sub-adder blocks with input carries speculated in a carry lookahead approach. The Error Tolerant Balancing Adder (ETBA), direct descendant of the ETAII, uses an error balancing technique based on multiplexers to mitigate the relative error in case of incorrect carry speculation. The Inexact Speculative Adder (ISA) has generalized and optimized the architecture of speculative compensated adders by shortening the speculation overhead and by introducing a dual-direction compensation mechanism that improves both circuit performances and accuracy. However, the multiplexers required for a good error compensation still represent a substantial area and energy overhead, particularly for low-power implementations.

This section presents the use of the disclosed invention to optimize an approximate adder circuit. This exemplary embodiment of the technique called the Carry Cut-Back (CCB) approximate adder allows to better understand how the disclosed invention enables to optimize the circuit implementation cost together with the circuit behavior in terms of arithmetic precision.

By monitoring high-significance carry stages to logically cut the carry chain at lower-significance carry stages, the use of the CCB technique prevents the critical-path activation, therefore relaxing the timing constraints in the entire design and strongly improving the circuit efficiency. This approach also guarantees low relative errors of floating-point type. A brief design methodology is presented together with results and a comparative analysis for both high-performance and low-power circuit implementations.

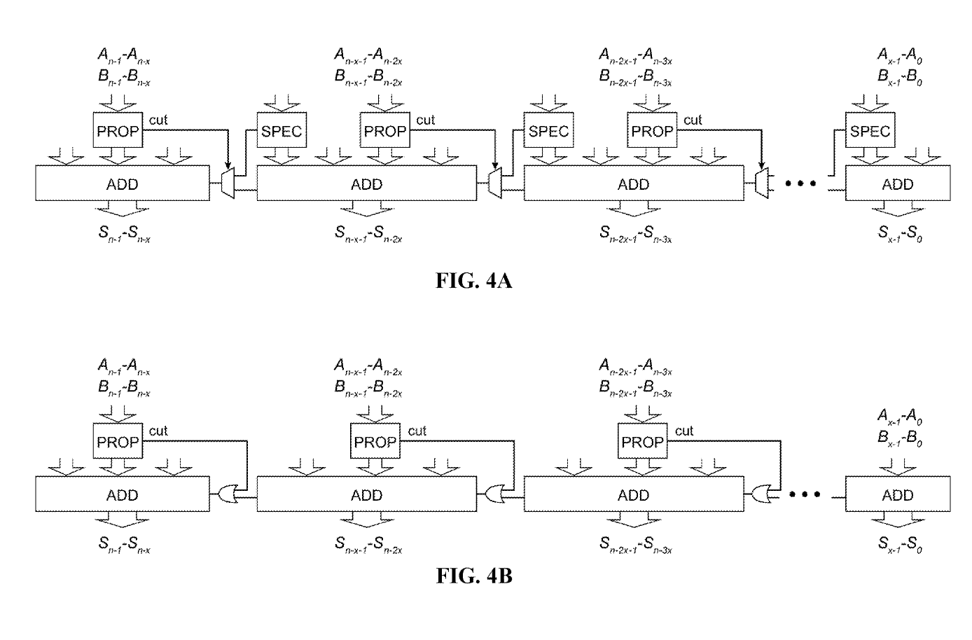

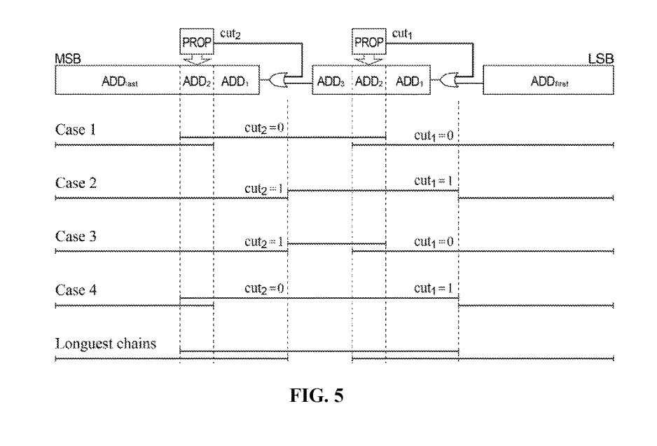

Next, the proposed architecture is discussed. Block diagrams of the disclosed adder are depicted in FIGS. 4A-4B, with Ai, Bi, Si representing the two input operand bits and the output sum bit at the i^{th} position of the binary addition, respectively. The CCB adder is based on a conventional fixed-point adder circuit, formed by the chain of ADD blocks, with insertion of several multiplexers or logic gates that can cut the carry propagation chain to shorten the effective critical path.

The carry-propagate block (PROP) logically monitors one or several carry stages and outputs the cut-back signal to trigger the logic cutting of the carry chain. The logic cutting occurs at lower-significance position in the carry chain, by multiplexing the real carry with an alternate path that consists in a carry speculated in an optional carry speculator block (SPEC). Taking place at a lower-significance stage, the carry cut-back technique guarantees a low relative error. Chosen shorter than the carry chain, the alternate path can either be a carry speculated from the SPEC from one or several carry stages as in FIG. 4A, or simply a logic 0 or logic 1 signal meaning that the logic cutting applies a straight cut of the carry chain using a monotonic gate as in the example of FIG. 4B (cut=1 dictates the OR gate output regardless of its second input).

The cut-back module appears functionally as a feedback between two carry-chain positions, but is not a recursive loop as it monitors the local carry propagate and generate signals directly precomputed from the operand inputs. Hence, it cannot influence the stability of the circuit.

The main advantage of this approach remains in its timing characteristic. Typically, the carry propagation chain of an addition is naturally broken because of short-size operands or by the distribution of the input bits. Spanning over the whole adder length, the critical path is only activated if all the stages are in propagate mode. Even if the adder within the CCB architecture physically contains the entire carry chain through the ADD and multiplexers, this path can never be fully activated. By monitoring one or more carry stages of the adder, the PROP quickly detects such risk and switches to a shorter path to be used instead, ensuring that the adder circuit meets tighter timing constraints.

FIG. 5 illustrates a case study of the longest carry propagation chains that can flow through a CCB adder built for this explanatory example with two cut-backs in an OR-cut implementation as in FIG. 4B. Each cut-back module splits the carry chain with two possibilities:

1. cut=0: No deliberate logic cutting in the typical case, i.e. the carry chain is naturally broken somewhere in the PROP. The critical path is limited since it cannot entirely cross over the PROP. The case 1 in FIG. 5 shows two examples of such behavior.

2. cut=1: All the stages within the PROP are in propagate mode. The carry chain necessarily propagates through the PROP and there is a risk of long critical-path activation if the other non-monitored stages are also in propagate mode. Therefore, by intentionally cutting the carry chain, its maximum length still remains limited. The case 2 in FIG. 5 shows two examples of such behavior.

Cases 3 and 4 both contain one naturally broken chain (cut=0) and one intentional cut (cut=1). Despite the fact that the full carry chain physically exists in the design, no input combination can activate it from the start to the end. It is a false path and can therefore be excluded from the timing analysis. The effective critical paths in FIG. 5 sum up the longest propagate chains that can occur in the circuit among the different cases. Insertion of more carry cut-back modules, possibly overlapping each other, would lead to shorter effective critical paths.

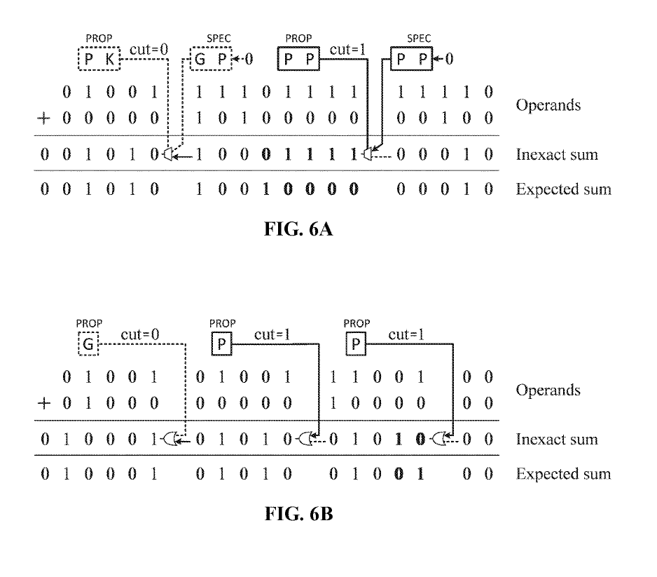

Regarding arithmetic and errors, the CCB addition arithmetic is illustrated in FIGS. 6A-6B. Errors only occur with the concurrence of three factors:

1. Sequence of propagate signals spanning the entire PROP bit-width, triggering the cut.

2. Sequence of propagate signals spanning the entire SPEC bit-width, making the exact carry prediction impossible with the SPEC bits only.

3. Wrong guess of the carry that inputs the SPEC (FIG. 6A) or that directly substitutes for the real carry (FIG. 6B). This occurs with a 50% binary probability.

An error occurs in the right-hand path of FIG. 6A because of the simultaneous occurrence of the three aforementioned properties. In the OR-cut implementation of FIG. 6B (without SPEC), the cut signal is also the guessed carry. The first condition of error occurrence is met for the two right-hand paths. The guess unintentionally follows the real carry and leads to a correct sum in the central path, but happens to be wrong and leads to a faulty sum in the right-hand path.

Occurrence of an error implies that one or both operands have non-zero bits at the PROP position. As the error occurs at the carry cut, at a lower-significance position, the expected sum is necessarily much larger than the introduced error. In the computation of FIG. 6A, the absolute error is 16 while the expected sum is 43,265 so the relative error is 0.04%. In the example of FIG. 6B, the relative error is only 0.006%. Such low relative errors are typical in speculative adders for calculations involving large value operands. However, it is the worst case that gives the upper-bound relative error and defines the minimum floating-point precision of the adder.

It is interesting to note from FIGS. 6A-6B that the error caused by the cut can propagate on many bits, but seems to keep the magnitude of the carry cut-back position, to wit, the first wrong bit. This statement that seems straightforward with the example has to be demonstrated carefully. Indeed, a successive series of erroneous sum bits can result in different errors. Let Si, Ci and Pi denote the sum, carry-in and propagate signals of the i^{th} stage addition, respectively. The sum and carry propagation are defined by:

Sᵢ=Pᵢ⊕Cᵢ Eq. (1)

Pᵢ=1 [symbol] Cᵢ₊₁=Cᵢ Eq. (2)

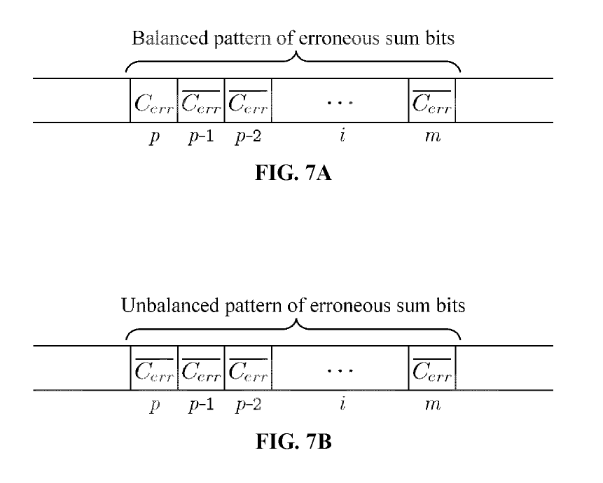

Assume a carry error at the i^{th} bit of the adder, with an erroneous carry of value Cₑᵣᵣ. The sum bit and the carry-out depend on the value of Pᵢ. If Pᵢ=1, Equation (1) gives Sᵢ=C̅ₑ̅ᵣ̅ᵣ̅ and Equation (2) propagates the wrong carry Cₑᵣᵣ to the next stage, where the same formulae apply again. If Pᵢ=0, Equation (1) gives Sᵢ=Cₑᵣᵣ and the wrong carry is not propagated, so the next stage addition is correct. Assuming that the erroneous sum spreads from the m^{th} to the p^{th} stage, the error pattern appears as shown in FIG. 7A. Just as in FIGS. 6A-6B, the last faulty bit counterbalances the first ones and the absolute error value is reduced to:

2^{p}−2^{p-1}−2^{p-2}− . . . −2^{m}=2^{m} Eq. (3)

This result is valid if the carry propagates normally. But there can be more than one cut-back module, and if all the stages between two cut-backs propagate, it could disrupt the normal propagation driven by Equation (2). Thus, the previous result needs to be recomputed for that case. Assume the same carry error (Cᵢ=Cₑᵣᵣ) in a propagating stage (Pi=1, else there would be no carry-chain perturbation). If another cut-back happens to guess the same faulty carry Cₑᵣᵣ, then it transparently follows Equation (2) and the previous result holds. But if the carry-cut is in the opposite direction C̅ₑ̅ᵣ̅ᵣ̅, as it runs against Equation (2), it reverses the error: the carry, that was false until now, comes back to the value of the expected addition, so the next stage is correct. But the current sum, determined by Equation (1), is Sᵢ=C̅ₑ̅ᵣ̅ᵣ̅. The error pattern appears this time as in FIG. 7B. All the erroneous bits are in the same direction and the absolute error is simply their sum:

2^{p}+2^{p-1}+2^{p-2}+ . . . 2^{m}=2^{p+1}−2^{m} Eq. (4)

This error is of much higher magnitude than in the first case, but can only occur if several carry-cuts happen in opposite directions. To avoid such dramatic errors, the SPEC guess or the straight carry-cut must be chosen in the same direction for all the CCB modules of the adder.

Having validated the fact that any error has the magnitude of the cut-back bit that caused it, the low impact of the error on the expected sum should be demonstrated. The worst case happens when the error magnitude is the highest on the lowest expected calculation.

Occurrence of an error implies that the three aforementioned error factors are realized, this assumes that the PROP and SPEC intercept propagate signals only. All the non-zero operand bits producing those propagates add up to the expected sum:

Standing at higher-significance positions than the carry error, the PROP non-zero bits significantly contribute to maximizing the expected result and thus to minimizing the worst-case relative error.

Positioned directly before the carry-cut, the SPEC non-zero bits contribute in a lower extent to increasing the sum by attenuating a portion of the magnitude of the error. Although, they participate equally with the PROP bits in reducing the rate of errors.

When the SPEC guess or the straight carry-cut is 0, i.e. speculating a low carry, an error happens when replacing a real carry at state 1 coming from a carry generate stage. Added to the SPEC propagate stages, this generate stage further increases the expected sum to 2^{m}.

Whenever a carry-cut error occurs, while it keeps the magnitude of the cut bit significance, i.e. an arithmetic error of value 2^{m}, the sum is always expected to be greater than:

2^{m}+Σ_{kεPROP}2^{k} and Σ_{kεSPEC}2^{k}+Σ_{kεPROP}2^{k} Eq. (5)

leading to a relative error lower than:

2^{m}/(2^{m}+Σ_{kεPROP}2^{k}) and 2^{m}/(Σ_{kεSPEC}2^{k}+Σ_{kεPROP}2^{k}) Eq. (6)

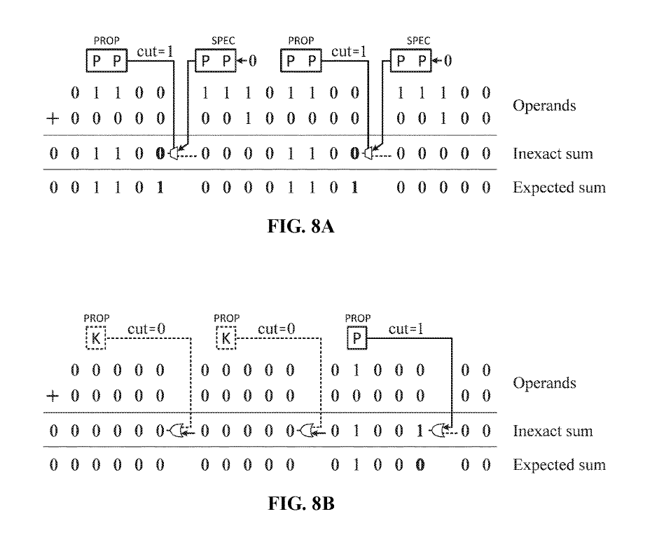

in the cases where the carry guess is at 0 and 1, respectively. This result holds if multiple errors occur in different carry-cut modules as the ratio of error over sum is preserved. A floating-point precision is thus configurable at design time by sizing and positioning PROP and SPEC and selecting the carry guess. It is easy to verify that the worst-case relative error in the implementation of FIG. 6A is 7.7%, as shown in FIG. 8A, and 12.5% for the implementation of FIG. 6B, as shown in FIG. 8B. Those errors correspond to precisions between 4 and 5 bits. Note that all cut-back modules lead to an error in FIG. 8A, but as the ratio or error over sum is the same for each error, the same worst-case would be computed with a single error, as in FIG. 8B.

Next, the circuit implementation is discussed. The CCB technique allows considerable improvements concurrently in circuit implementation and accuracy control. Both PROP and SPEC can be implemented in a carry-lookahead approach and should have very short bit-widths to limit overheads. Their areas can fortunately be balanced as the adder segments that they overlay can be cut down to simple sum generators. Moreover, the delay overhead is limited by the slowest between PROP and SPEC since they are executed in parallel.

The CCB adder physically contains the entire adder carry chain but the CCB technique prevents from its full activation and splits the critical path into multiple shorter paths. However, the adders in this exemplary case have been generated in existing Electronic Design Automation (EDA) environment for which long-established Static Timing Analysis (STA) used in synthesis tools cannot easily identify those timing exceptions. It is thus necessary to provide the tools with additional timing constraints to manually exclude from the timing analysis all the false paths generated by the CCB modules. This additional information prevents the synthesis tools from unnecessarily trying to meet delay constraints on them.

The CCB adder enables to dissociate the precision from the dynamic range of the adder, which is fixed by the total adder bit-width. It offers a large design space to minimize the application quality loss and maximize the savings by trading off mean, maximum and rate of errors, configurable by choosing positions and bit-widths of the CCB modules. The error rate depends on the number of cut-back modules and of the PROP and SPEC bit-widths. The maximum error can be adjusted mainly by sizing the PROP bit-width and positioning the carry-cut (i.e. sizing ADD1), and to a lesser extent by modifying the SPEC bit-width and input guess. Optimum trade-offs to adjust Signal-to-Noise Ratio (SNR), Root Mean Square (RMS) error or any other accuracy metric can be achieved using the same models than those built for speculative adders.

Next, the results are discussed and comparative study is shown. The metrics used to characterize approximate adders in this work are based on the relative error (RE), which has the advantage of being independent of the size of the adder. It is defined as:

RE=|(Sₐₚₚᵣₒₓ−S_{exact})/S_{exact}| Eq. (7)

where Sₐₚₚᵣₒₓ and S_{exact} are the approximate and correct sums of an addition, respectively. The main metric considered is the maximum of the relative error (RE_{MAX}) that delimits the minimum precision of the circuit. The RMS of the relative error (RE_{RMS}) is also taken into account as it is proportional to the SNR and interesting for many applications, particularly in multimedia processing.

Approximate adders are commonly characterized and validated through the simulation of random sets of inputs. As a matter of fact, the presented results are statistical estimations depending on the random sample distribution (occurrence of specific patterns initiates errors in specific adders). In this exemplary embodiment, adders are characterized using two samples of five million unsigned random inputs. First, a logarithmically uniform distribution exhibiting a very large dynamic range is used to detect the worst-case error RE_{MAX}. Then, a uniform distribution is used to estimate RE_{RMS}. In this example, several 32-bit approximate adders have been synthesized for low-power (0.8 GHz) and high-performance (3.3 GHz) in an industrial 65 nm technology. Over 5000 implementations with diverse error characteristics have been investigated by varying design parameters in a synthesis script, a few representative cases are shown in the results. All circuits have been generated with regular block structures from high-level descriptions in order to benefit from the compiler's optimization libraries and most favorable architecture choices to fit each timing constraint. Delay, area and power have been estimated using Synopsys Design Compiler.

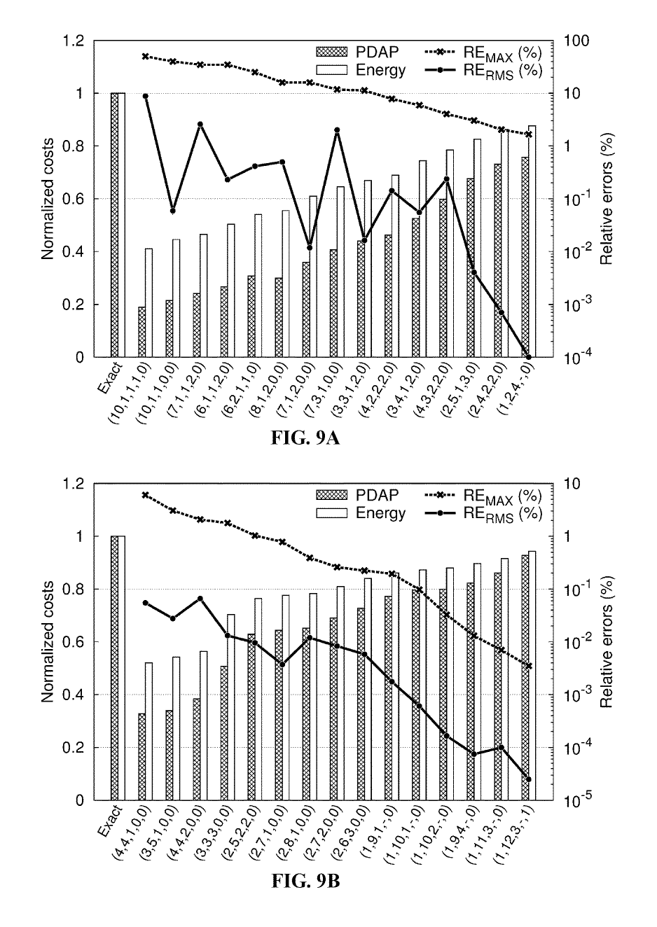

Improvements in circuit implementation have been quantified in terms of energy costs and Power-Delay-Area Product (PDAP) costs, and are shown for a selection of 32-bit CCB adders synthesized in a 65 nm technology at 3.3 GHz in FIG. 9A and at 0.8 GHz in FIG. 9B. In FIGS. 9A-9B, the double bars correspond to the implementation costs of a selection of CCB adders (which parameters are shown on the horizontal axis) in terms of energy and PDAP scaled on the left axis, and normalized to the exact adder implementation represented by the left double-bar. The lines represent the maximum relative errors (REMAX) and RMS relative errors of each CCB adder implementation, calculated in percent and scaled on the right axis. CCB adders are denoted by the quintuples (number of cut-backs, ADD1 bit-width, PROP bit-width, ADD3 bit-width, SPEC bit-width), assuming a regular block structure and the optimizations described previously. These figures highlight the large design space and error engineering possibilities enabled by the proposed adder. The CCB design parameters allow to tune the precision on more than three orders of magnitude of errors with optimal circuit efficiency.

Timing constraints have a significant influence on the results. At equivalent precision, low-speed implementations show better savings than high-performance ones compared to the exact adders. At 2% REMAX, CCB adders at 3.3 GHz achieve 14% energy savings and 27% PDAP reductions against 44% and 62% for adders at 0.8 GHz. This is due to the fact that high-speed circuits require more CCB modules to split the carry chain into smaller pieces, but at the cost of additional hardware overhead.

FIG. 9B presents a small but sharp drop in circuit efficiency at 1.7% REMAX. This corresponds to the precision from which the design becomes delay constrained. Indeed, higher precision demands wider PROP, SPEC and ADD1 which all lie in the effective critical path. This does not appear for 3.3 GHz adders which are always tightly constrained. Note that RERMS and REMAX follow the same trend, but with a larger variability for high-speed and low-precision adders. Those generally contain several cut-back modules, so a small change in their structure repeated over many of them strongly impacts the overall error rate and mean.

TABLES 1A-1B compare the costs and PDAP of 32-bit CCB adder with other 32-bit approximate adders also synthesized in a 65 nm technology at 3.3 GHz in TABLE 1A and 0.8 GHz in TABLE 1B. Only ETBA and ISA are shown for comparison as they exhibit enough savings and low errors for a bit-width of 32 bits. Original ETBA has been considered, but a modified ETBA has been built with fixed carry guess as the original variable guess was strongly weakening its efficiency. For given REMAX, the best implementation of each architecture has been selected. All structures are regular and denoted by n-tuples of bit-widths: (block size) for ETBA, (block size, SPEC, correction, reduction) for ISA and as already stated for CCB adders.

Among high-performance adders (TABLE 1A), CCB and ETBA architectures are completely overtaken by the ISA for very low precisions (35 REMAX). In this case, the minimal architecture of the ISA optimally fits the difficult delay constraint without loss of circuit efficiency. The situation reverses at higher accuracy, for which the need of wider speculation and compensation hardware in the critical path reduces the efficiency of ETBA and ISA. At 6% REMAX, the CCB adder performs 11% better than the ISA and 21% better than the ETBA in terms of PDAP. Increasing the precision to 3% REMAX widens the gap with the CCB adder performing 24% better than the ISA. For low-power implementations (TABLE 1B), the CCB adder always outperforms the state-of-the-art. Indeed, low speed allows smaller and more energy-efficient architectures to be used in the addition sub-blocks. The speculation and compensation blocks of ISA and ETBA thus become a large area and energy overhead. Thanks to its lightweight cut-back mechanism, CCB architectures exhibit 18-30% PDAP reductions compared to ISA and 40-45% compared to ETBA while maintaining equal or greater precision. Moreover, while circuit savings of ISA and ETBA progressively disappear at higher accuracy compared to the exact adder, the CCB architecture still offers significant savings. Up to 14% energy savings and 22% PDAP reductions are demonstrated for 0.1% REMAX, corresponding to 11-bit precision, i.e. the mantissa precision of a standard 16-bit FPU.

As shown above, according to some aspects of the present invention, a novel architecture of approximate adder optimizing circuit timing together with arithmetic precision is provided. By using a logic monitoring of carry stages to trigger logic cutting of the carry chain, the Carry-Cut Back (CCB) technique prevents the critical-path activation, therefore relaxing timing constraints and strongly improving circuit implementation. In this approach, high-significance carry stages are monitored to cut the carry chain at lower-significance positions to guarantee a precision of floating-point type with a marginal overhead. For a worst-case relative error of 2%, the results for 32-bit adders show energy savings up to 44% and PDAP reductions of up to 62% compared to low-power conventional circuits. Besides, the proposed adder surpasses the state-of-the-art approximate adders, performing up to 30% better than the ISA and 45% better than the ETBA in terms of PDAP. Thanks to the instinctive floating-point precision which ensures that all errors remain below an upper bound, this approximate adder could help designing low-power and highly-efficient hardware accelerators with an acceptable and perfectly predictable impact on their accuracy.

Next, the general circuit optimization method is discussed, according to another aspect of the present invention. Embodiments of the present invention include a method for optimizing a digital circuit by co-designing the digital circuit behavior and the digital circuit implementation by artificially introducing false paths in the digital circuit. The method comprises transforming of the digital circuit behavior to improve the digital circuit implementation by transforming at least one signal path of the digital circuit into a false path. The term “digital circuit implementation” may refer to the digital circuit costs (e.g. power consumption, area), the digital circuit performance (e.g. speed, IPS and/or FLOPS), and/or the digital circuit efficiency (e.g. FLOPS per watt). It must not be limited to the cited circuit benchmarks and figures of merit.

In addition to the current description, embodiments of the method comprise all the processes and steps required in order to design the circuits and implement the techniques described in the “General circuit technique” and “Application to approximate adders” sections.

The method can be used on different digital circuits in various technologies, including but not limited to Application-Specific Integrated Circuits (ASICs), Programmable Logic Devices (PLDs) or Field-Programmable Gate Arrays (FPGAs).

The method can be used at one or more stages of an overall circuit synthesis scheme. For example, any of the false-path transforming method disclosed can be utilized to optimize or improve the design after logical synthesis. The false-path transforming method disclosed can also be used after placement and routing is performed in order to improve the circuit implementation. At this stage, additional physical information, such as interconnect delay, is typically available and delay times can be more accurately computed.

Any part of the disclosed method can be performed using software stored on a computer-readable medium and executed on a computer. Such software can comprise, for example, an Electronic Design Automation (EDA) software tool used, for instance, for logical or physical synthesis. Such software can be executed on a single computer or on a networked computer (e.g. via the Internet, a wide-area network, a local-area network, a client-server network, or other such network).

For clarity, only certain selected aspects of the software-based implementations are described. Other details that are well known in the art are omitted. For example, it should be understood that the disclosed technology is not limited to any specific computer language, program, or computer. For the same reason, computer hardware is not described in detail.

Embodiments of the present method for optimizing a digital circuit comprise evaluation of the hardware area, timing and power cost of a given circuit implementation in a quick and automated fashion in order to select the best signal path candidate and to find the optimal transforming of this signal path. The process should for instance model the circuit area, delay and power as accurately as possible. The behavioral alteration process can also be automated to evaluate the transformed behavior, accuracy or arithmetic precision.

For example, according to still another aspect of the present invention, it is possible to transform a signal path into a false path. False paths are traditionally unexpected byproducts of circuit design. Finding false paths and obtaining false-path information, known as delay constraints or timing exceptions, allow to relax timing constraints on signal paths. It can enable the tools to achieve desired design performance (e.g. power, area, and/or speed) or timing closure by focusing effort on real paths instead of false paths. Thus, many articles and patents have described techniques to discover them in the circuit netlist by analytical or numerical ways. The novelty and main interest of the disclosed method is to artificially introduce and exploit false paths to optimize the implementation of the digital circuits.

Preventing a full activation of a signal path in the digital circuit by inducing a false path with the disclosed method allows to relax the timing constraints that can result in lower circuit implementation cost, higher yield, or earlier arrival times of signal paths. In some cases, if a signal path fails to fit the delay constraint, the use of the disclosed method can make it possible to fit the delay constraint without the need to redefine design specifications, or without the need of costly synthesis methods such as upsizing cells and transistors, adding buffers, parallelizing the netlist or adding pipeline stages. The disclosed method can also be used to improve delay safety margins on a signal path, improving the robustness of its output against PVT variations. In the case of FPGAs, the disclosed technique can be particularly interesting to overcome their hardware limitations (e.g. fixed number of LUTs), interconnect constraints and their limited operational speed.

The transforming of the circuit by introduction of a false path is desirably performed so that circuit behavior (functionality) of the circuit is unchanged. But in most cases, the transforming of a signal path into a false path modifies the signal path behavior, and thus alters the overall circuit behavior. It is thus important to use this transforming carefully.

In exemplary embodiments of the proposed method, the transforming of the circuit is applied either by considering behavioral specifications of the digital circuit, or by considering accuracy specifications of the digital circuit in order to control and limit the behavioral alteration. In another embodiment of the invention, wherein the digital circuit is fully or partially used for an arithmetic computation, the transforming of the digital circuit is applied so that the digital circuit is configured to compute with either a reduced precision or a reduced accuracy when using the induced false path compared to when using the original signal path.

In one embodiment, the method comprises selecting, in the digital circuit, the signal path on which the method is applied, whereby the signal path comprises at least 2 logic instances, and transforming the signal path into a false path, whereby the transforming comprises a logic monitoring of the digital circuit to output a cut-back signal in case a determined risk of a full activation of the signal path is detected in the logic monitoring, and a logic cutting being configured to be triggered by at least the cut-back signal to prevent the full activation of the signal path, the logic cutting being configured to switch, the switching either maintaining the signal path itself, or preventing the full activation of the signal path by substituting it for an alternate signal path, thereby inducing the false path.

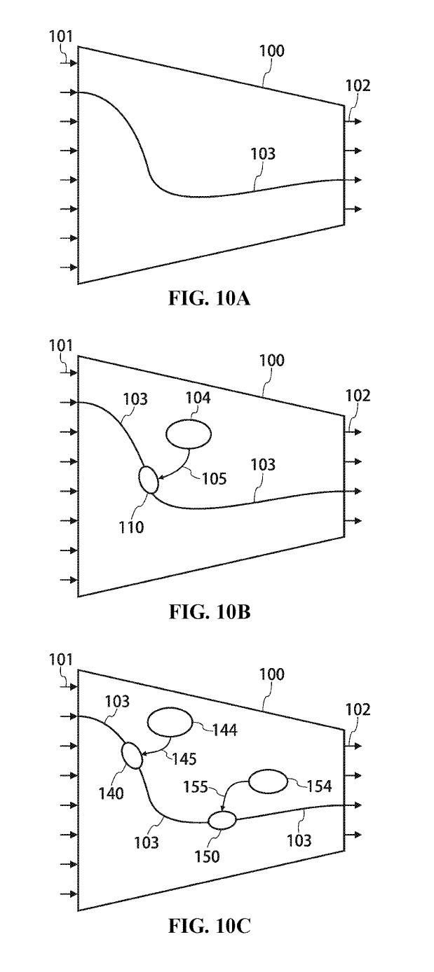

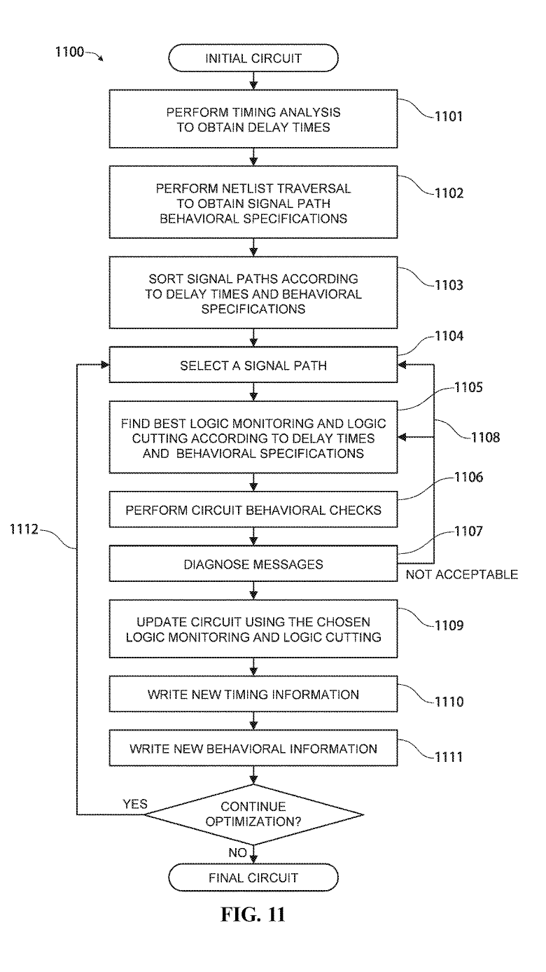

The results of exemplary successive steps of the disclosed method are illustrated with FIGS. 10A-10C. All those figures are circuit block diagrams representing the digital circuit 100 comprising at least one input 101 and at least one output 102 as in FIGS. 1A-1C. FIG. 10A illustrates the initial circuit with the original signal path 103 on which the method is applied. FIG. 10B-10C illustrate two possible states of the digital circuit after transforming of signal path 103 into a false path, implementing different configurations of logic cutting and logic monitoring. FIG. 10B shows an example of logic cutting of the signal path 103 with a single cut, with the inserted logic monitoring element 104 and the logic cutting element 110 triggered by the cut-back signal 105. FIG. 10C shows another possible transforming, this time with logic cutting of the signal path 103 comprising two cuts, with the inserted logic monitoring elements 144 and 154 and logic cutting elements 140 and 150 triggered by the cut-back signals 145 and 155. The different elements can be implemented in various ways as in the aforementioned disclosed circuit technique and approximate adders, and as exemplarily illustrated in FIGS. 1B-1C.

In one embodiment, in the signal path transforming, the logic monitoring is further configured to monitor one or more signals of higher significance than the signal at the position of the logic cutting selector in the signal path. In the case of arithmetic computations, the significance can be the arithmetic significance at the position of the signal. In many cases, a significance ranking can be obtained with simulations or traversals of the gate-level netlist or register-transfer level (RTL) signals.

In some embodiments, the logic cutting is configured to be triggered by at least the cut-back signal outputted from the logic monitoring when the logic monitoring detects a determined risk of full activation of the signal path. In the disclosed invention, the logic cutting is configured to switch between at least the signal path and an alternate signal path. The logic cutting may comprise a multiplexor or a logic gate to switch between the signal path and the alternate signal path.

The logic cutting is not limited to combinational logic elements, it may utilize pre-computed or stored signals and values for the logic cutting or for the alternate signal path. The logic cutting can also be a straight cut of the signal path, the alternate path is thus reduced to setting a static value (logic 0 or logic 1), or a determined or stored dynamic value, in those cases the logic cutting can comprise at least a logic gate or a storage element. For those reasons, and for leaving full optimizations of the circuits to circuit synthesis tools, the cut-back signal can be both an active-low or active-high trigger.

The alternate signal path can be configured to be smaller or faster than the original signal path. This is often the case at design time, before full synthesis, timing analysis and layout generation, but as the synthesis tools generally optimize the timing of all the circuit paths to fit a determined timing constraint, the signal path and the alternate signal path might have similar delays. Nevertheless, the use of the disclosed method would benefit to the circuit by relaxing the constraints on the signal path.

In one embodiment of the present method, the logic cutting selector and alternative path can further be configured to partially or fully reuse existing hardware. This is recommended in order to minimize the overhead induced by the proposed technique, as for instance in the aforementioned use of the technique in an approximate adder, the alternate path can be a carry speculated from a few carry stages, it can reuse existing hardware in its implementation as those carry propagation stages are already computed in the conventional adder hardware.

In some embodiments, the logic monitoring is configured to monitor a part of the digital circuit, and to output a cut-back signal in case a determined risk of a full activation of the signal path is detected in the monitoring, the cut-back signal triggers the logic cutting to prevent the full activation of the signal path.

The mentioned determined risk of a full activation of the signal path that can be determined in accordance with the additional delay and cost of hardware implementation of the logic monitoring, with possible consideration of existing hardware, it should not be construed as limiting in any way. The determined risk of a full activation of the signal path might be overestimated. For instance, monitoring of a single carry stage of a 32-bit adder will output a cut-back signal that triggers the logic cutting with a probability of 0.5, corresponding to the case for which the carry stage is in propagate mode, despite the full activation of the entire adder carry-chain happens only when all the stages are in propagate modes, which happens with an extremely low probability. The determined risk of a full activation of the signal path might be under-estimated because of the designer's choice, or because the signal path might naturally be a false path due to other logic combinations (for example if an adder circuit is used as a counter for which the computations that lead to a full activation of the carry chain are never executed).

In some embodiments, the logic monitoring may comprise but not be limited to combinational logic elements, it may utilize pre-computed or stored signals and values, thus it may comprise at least a logic gate or a storage element.

In some embodiments, the logic monitoring is configured to monitor at least one signal of higher significance than the signal at a position of the logic cutting selector in the signal path. This method, called the cut-back technique, can minimize the alteration of the digital circuit behavior. The logic monitoring can monitor signals resulting from various computations that can guarantee no or low impact of the behavioral alteration induced by triggering the logic cutting to select the alternate signal path. The alteration of the digital circuit behavior with the logic cutting can also be made acceptable for the digital circuit specifications or tolerated by the designer's choice thanks to a logic monitoring of higher-significance signals that guarantees the low relative impact of the logic cutting with occurrence of specific combinations of monitored signals. As an exemplary embodiment, applying the disclosed technique on the carry chain of an adder circuit, the logic monitoring of a high-significance carry stage of the carry chain and the logic cutting of the carry chain at a lower-significance position can ensure that the behavior alteration due to the logic cutting has low impact on the overall result of an unsigned addition, this example is explained in details afterwards. When the digital circuit is fully or partially used for an arithmetic computation, for instance in an arithmetic operator or in the data path of a codec, a hardware accelerator or a FPU circuit, embodiments of the present invention allow the computation to be executed with a reduced binary precision when the alternate signal path is selected by the logic cutting selector, compared to when the signal path is selected.

In one embodiment of the present method, the logic monitoring can further be configured to partially or fully reuse existing hardware. This is recommended in order to minimize overhead of using the proposed technique, as for instance in the aforementioned use of the technique in an approximate adder, the logic monitoring of carry propagation stages can reuse existing hardware in its implementation as those carry propagation stages are already computed in the conventional adder hardware.

In one embodiment, the transforming of the signal path can comprise a plurality of logic monitoring and logic cutting in the signal path, in the same way as stated in the circuit technique description and illustrated in FIG. 3A-3D. Logic monitoring and logic cutting may be configured with multiple cuts of the same signal path.

In other embodiments, the different elements instantiated by the disclosed method can be configured to partially or fully share hardware, particularly in the cases of inserting or using multiple logic monitoring elements, logic cutting elements, cut-back signals and alternate paths. For instance, one logic monitoring element can trigger a plurality of logic cutting elements, possibly on a plurality of signal paths, this is particularly interesting to limit the logic monitoring hardware overhead. In another exemplary embodiment, one logic cutting element can substitute the signal path with a plurality of alternate paths. In an embodiment of the disclosed method, the number of logic cutting, logic monitoring and their implementation can be determined by either behavioral specifications or accuracy specifications. For instance, longer cuts or fewer cuts can lead to higher computation accuracy.

Not illustrated for the sake of simplicity, an embodiment of the method can further comprise logic enabling in order for the technique to be reconfigurable and adaptive. In an exemplary embodiment, an enabling signal or logic element can be configured to enable or disable the logic monitoring, the logic cut or the alternative path. In another exemplary embodiment, the enabling of the aforementioned elements can be adapted to the digital circuit operative conditions or requirements, based for example on delay or precision conditions. For instance, the logic monitoring or the logic cutting can be enabled when the digital circuit must operate at a certain speed, and disabled when it can operate at a lower speed. The logic monitoring, logic cutting and alternate paths can be made programmable in order to modify their behavior in many ways, comprising but not be limited to modifying the logic monitoring's determined risk sensibility, the alternate signal path or the choice of alternate path in the case of a plurality of alternate paths, or the way of combining of a plurality of elements in the case a plurality of elements are combined.

Not illustrated for the sake of simplicity, some embodiments of the transforming comprise generating multiple false paths inducing reciprocate behavior alterations, i.e. alterations that partially or fully cancel out each other. One exemplary embodiment comprises logic cutting with multiple logic cutting elements inducing opposite or inverse behavioral alterations, the overall circuit behavioral alteration can be minimized. Another exemplary embodiment comprises a logic monitoring with a logic monitoring element that triggers logic cutting with multiple logic cutting elements so that the behavior alterations induced by the multiple logic cutting elements have identical occurrences. An exemplary embodiment comprises logic cutting with multiple logic cutting elements inducing reciprocate or canceling-out behavioral alterations (when their alternate signal paths are selected) that can be triggered by a logic monitoring with a single logic monitoring element, leading to simultaneous partial or full canceling-out of the induced behavioral alterations. This exemplary embodiment allows to relax circuit timing with low or no overall circuit behavioral alteration when the alternate signal paths are simultaneously selected, compared to when the signal paths are simultaneously selected.

In some embodiments, the implemented method can modify already instantiated or used elements of logic monitoring and logic cutting, for instance in an incremental way, in order to exchange them for a more favorable transforming considering latter transforming of the circuit. The modification can consist but not be limited in a displacement, change, or deletion of the configuring of logic monitoring or logic cutting. In some embodiments, the modification is performed in order to partially or fully cancel-out the overall circuit behavioral alteration either with at least one other instantiated logic cutting or logic monitoring, or in a process of instantiating another logic cutting or logic monitoring.

In some embodiments, the disclosed method can be used in order to optimize an FPU or any circuit configured to compute partially or fully using the floating-point format. Because of their high arithmetic complexity and high power consumption, the use of the disclosed circuit optimization method in an FPU circuit is particularly interesting to reduce circuit costs or improve performances. As an exemplary embodiment, the disclosed invention can be used in the mantissa calculation of a FPU circuit, comprising but not limited to additions, multiplications, MAC or FMA operations. Due to the use of the floating-point format, the FPU mantissa computation requires large fixed-point arithmetic operations but only collects a limited number of signals for its final output. For example, in the IEEE 754 standard, the addition, multiplication and FMA mantissa operations output 28, 48 and 72 bits, respectively, while the single-precision floating-point format only stores 23 bits for the mantissa. Such bit widths generally strongly constrain the design, increasing the area and power consumption or limiting the speed of the overall system. An embodiment of the disclosed method comprises the logic monitoring of high-significance signals in the mantissa computation and logic cutting of at least one of the signal paths of the mantissa computation. It is thus possible to relax the timing constraint or design cost of the mantissa computation circuit with minimal impact on the overall precision of the FPU. As the FPU precision is already limited by the rounding error, it is also possible to realize an FPU with no degradation of the precision by using the disclosed method. For example, if the logic cutting and alternate path induce arithmetic errors of value lower than or equal to the rounding error, the precision degradation can be lower than the degradation induced by the rounding.

Next, an exemplary implemented method is described. The flowchart of FIG. 11 shows an exemplary method 1100 for optimizing a circuit using the disclosed method. Although the operations of the disclosed method are described in a particular, sequential order for convenient presentation, it should be understood that this manner of description encompasses rearrangement. For example, operations described sequentially may in some cases be rearranged or performed concurrently. Moreover, for the sake of simplicity, the attached figure may not show the various ways in which the disclosed method can be used in conjunction with other methods. Additionally, the description sometimes uses terms like “find”, “evaluate” and “write” to describe the exemplary disclosed method. These terms are high-level abstractions of the actual operations that are performed. The actual operations that correspond to these terms will vary depending on the particular implementation and are readily discernible by one of ordinary skill in the art. Although not required, the exemplary method 1100 is performed after the initial circuit synthesis.

At process block 1101, a timing analysis is performed on at least one signal path of the circuit to obtain delay times. In an embodiment of the disclosed method, the timing analysis is capable of performing incremental analysis, which allows the designer to analyze and evaluate timing changes to a particular area or signal path of the circuit without having to calculate the timing of the entire circuit. In one embodiment, delay times may comprise timing exceptions induced by preceding use of the disclosed method.

At process block 1102, netlist traversal can be performed to obtain behavioral specifications on at least one signal path of the circuit from the behavioral specifications of the overall circuit. These behavioral specifications can serve either to identify the signal paths for which the behavior could be altered by the transforming into a false path, or to perform the transforming of the signal path in order to fit behavioral specifications after the transforming. In an embodiment, behavioral specifications of the overall circuit or of at least one signal path can be described from circuit behavioral information, comprising but not limited to RTL and gate-level codes (e.g. VHDL or Verilog), behavioral code, system-level modeling codes (e.g. SystemC, Matlab, or C++), synthesis pragmas, precision specifications, or accuracy specifications. In one embodiment, behavioral specifications may comprise behavioral alteration information induced by preceding use of the disclosed method.

At process block 1103, the at least one signal path of the circuit are sorted according to the delay times obtained at process block 1101 and the behavioral specifications obtained at process block 1102 in order to find the best possible candidates for transforming into a false path. The sorting can be based on a number of different criteria. In one exemplary embodiment, the slack values are considered in the sorting. In another embodiment, the significance of the output of the at least one signal path is considered in the sorting. In another embodiment, the at least one signal path can be sorted based on a circuit implementation cost function evaluating for instance area, delay, power cost required to for the signal path to meet timing closure.

At process block 1104, a signal path is selected from the at least one signal path sorted at process block 1103. In one exemplary embodiment, the signal path having the longest delay time and with the lowest constraints on the behavioral specifications is selected.

For certain circuits, used for instance in arithmetic operations, the best candidate for transforming might be predictable by the designer, for instance as the critical path of an adder circuit. Additional information provided by a script or by the designer could be provided in process blocks 1102, 1103 and 1104. Thus, in some embodiments, the sorting or selecting of the signal path can be directly or indirectly influenced by the designer, for instance using RTL code or gate-level design data augmented with architectural information such as assertions, pragmas, side-files or constraints, which could help either to identify the signal paths for which the behavior could be altered by the transforming into a false path, or which could help to identify the best transforming to fit behavioral specifications after the transforming. The designer may designate, for example, starting points, endpoints, through points, and a list of potential critical paths. The designer may also define or help to identity the configuration or type of logic monitoring and logic cutting to generate. Ideally, the delay times information, behavioral information, and/or additional designer information should help to at least narrow down the set of choices of signal path candidates to the transforming.

At process block 1105, the best transforming of the signal path into a false path is found in order to optimize delay times and behavioral specifications, as aforementioned in the description of the disclosed method. The best configuration of logic monitoring and logic cutting is estimated in order to monitor a determined risk of the full activation of the signal path and to fit behavioral alteration specifications, considering for instance determining the number of cuts, number of elements, position and implementation of logic monitoring and logic cutting in the signal path. In one embodiment, the logic monitoring and logic cutting can be estimated considering existing hardware in order to limit the area overhead.

At process block 1106, behavioral checks may be performed before continuing, in order to verify the correct behavior of the transformed circuit or signal path. They might comprise full or partial simulation of the behavior of the circuit with the transformed signal path.

At process block 1107, messages, such as error messages, warning messages and other types of verification messages, can be evaluated and diagnosed by the designer, in order to validate the transforming or resolve conflicts. Analysis, evaluation and diagnosis of these messages may lead the designer to modify the configuration, the behavioral specifications for improved performance, integrity and reliability of the electronic circuit design.

If the diagnosis or evaluation encounters unresolved problems or conflicts, then a repetition 1108 of either process block 1105 is performed to attempt another configuration of logic monitoring and logic cutting, or process block 1104 to attempt application of the disclosed technique on another signal path.

At process block 1109, the circuit is updated (or transformed) to include the best logic monitoring and logic cutting chosen at 1105. In some embodiments, the transforming can be obtained with an incremental update of the circuit implementation. As the relaxed timing constraints might strongly impact the circuit synthesis, other embodiments comprise a full or partial synthesis (or generation) of the modified circuit.

At process block 1110, new timing information can be written (or updated if already existing) in order to include timing constraints or timing exceptions induced by the generated false path. Examples of timing exceptions include but are not limited to: set false path, set maximum delay, set disable arc, set minimum delay. Such timing exceptions are practical when using commercial EDA software tools that do not allow access and modification to internal synthesis and timing analysis scripts.

At process block 1111, new behavioral information can be written (or updated if already existing) in order to include behavior or accuracy alteration induced by the generated false path. Examples of behavioral alteration information include but is not limited to: maximum error, average error, error rate, modified accuracy, modified precision, conditions of occurrence of false-path selection, position of the highest-significant error, resulting behavior or accuracy. They can comprise but not limited to updating or adding RTL, gate-level or system-level modeling codes. An efficient use of such information can also help reducing or avoiding the use of behavioral simulations that can quickly become time and power consuming.

The process can be repeated 1112 if desired from process block 1104 to continue the optimization on another signal path. Note that as the circuit transforming and updating could have modified the implementation of other signal paths in the circuit, the sorting performed at 1103 would thus need to be recomputed if not updated together with the timing information at 1110.

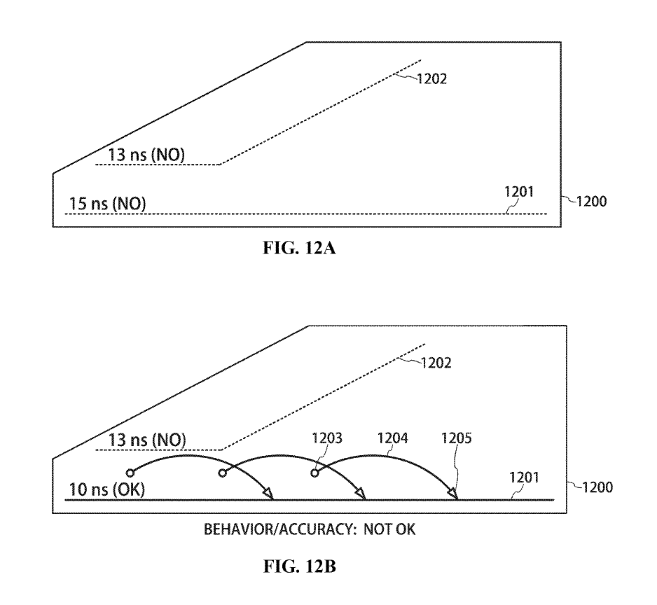

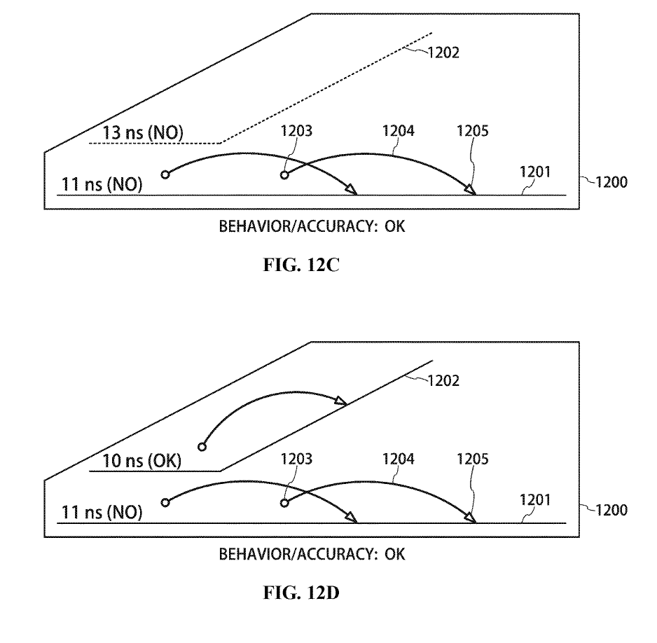

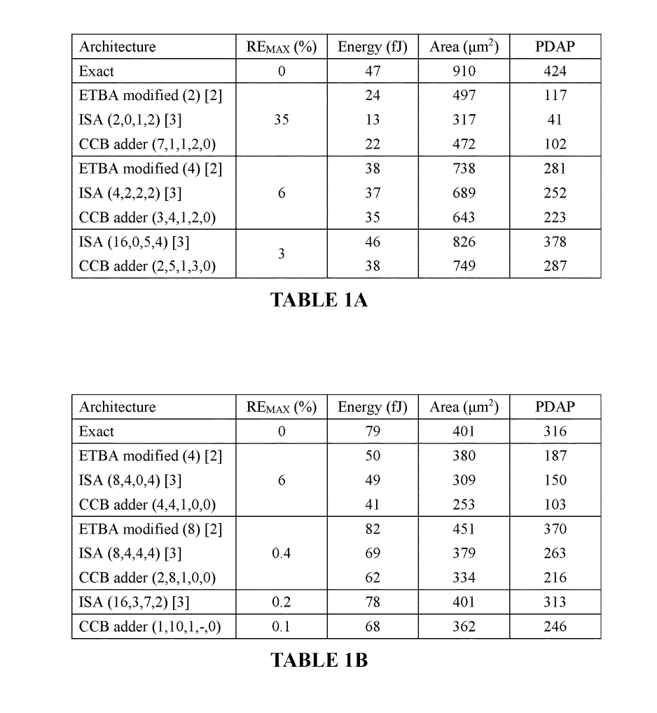

FIGS. 12A-12D illustrate the successive process steps of an exemplary method for optimizing a circuit using the disclosed method. The steps of the method can also be implemented in software, for example as computer-executable instructions that are recorded on a non-transitory computer readable medium, and the instructions configured to perform the method, when executed on a hardware computer. The non-transitory computer readable medium can include, but is not limited to a CDROM, USB drive, memory card, BluRay™ disk, thumb drive, portable hard drive, disk drive, storage disk, cloud memory banks. Those figures are synthetic circuit block diagrams illustrating the digital circuit 1200 comprising two signal paths 1201 and 1202. In FIGS. 12B-12D, a logic monitoring element displayed as 1203 triggers, with a cut-back signal as 1204, a logic cutting element as 1205.

FIG. 12A illustrates the initial circuit. Assume the required timing constraints is 10 ns. With 15 and 13 ns delay, respectively, so both signal paths 1201 and 1202 do not meet timing constraints.

First, the signal path with the most negative slack in the initial circuit, i.e. the slowest not meeting timing constraints, is selected: signal path 1201. FIG. 12B illustrates a possible state of the circuit 1200 with an exemplary transforming of signal path 1201. Thanks to this exemplary transforming with three logic monitoring and logic cutting elements, the signal path 1201 meets the 10 ns timing constraint. Although, this configuration does not meet behavioral or accuracy specifications. Another configuration is attempted with fewer logic cutting elements in FIG. 12C. With this new exemplary transforming with two logic monitoring and logic cutting elements, the signal path 1201 meets the behavioral specifications. Now at 11 ns, the transformed signal path 1201 does not meet the 10 ns timing constraint, but the optimization cost to fit this slack is smaller than with the original 15 ns.

Now, signal path 1202 is selected for transforming. FIG. 12C illustrates a possible state of the circuit 1200 with an exemplary transforming of signal path 1202. Thanks to this exemplary transforming with two logic monitoring and logic cutting elements, the signal path 1202 directly meets both the 10 ns timing constraint and the behavioral specifications. The optimization using the disclosed method ends. Other traditional methods to fit timing constraints can be used with smaller implementation costs than the initial circuit of FIG. 12A would have required.

While the invention has been disclosed with reference to certain preferred embodiments, numerous modifications, alterations, and changes to the described embodiments, and equivalents thereof, are possible without departing from the sphere and scope of the invention. Accordingly, it is intended that the invention not be limited to the described embodiments, and be given the broadest reasonable interpretation in accordance with the language of the appended claims.

1. A digital circuit comprising a signal path with a false path, whereby the signal path comprises at least 3 logic instances,
the digital circuit further comprising a logic monitoring element configured to monitor a part of the digital circuit, and to output a cut-back signal in case a determined risk of a full activation of the signal path is detected in the monitoring; and
wherein the signal path comprises a logic cutting selector element as one of the 3 logic instances, the logic cutting selector element being configured to be triggered by at least the cut-back signal to prevent the full activation of the signal path, the logic cutting selector element being configured to switch, the switching either maintaining the signal path itself, or preventing the full activation of the signal path by substituting it for an alternate signal path, thereby inducing the false path.

2. The digital circuit of claim 1 wherein the logic cutting selector element comprises a multiplexor configured to switch at least between the signal path and the alternate signal path.

3. The digital circuit of claim 1 wherein the logic cutting selector element comprises a logic gate configured to cut the signal path by substituting it for a static value.

4. The digital circuit of claim 1 wherein the logic cutting selector element comprises a storage element.

5. The digital circuit of claim 1 wherein the logic monitoring element comprises a storage element.

6. The digital circuit of claim 1 wherein the logic monitoring element is further configured to monitor at least one signal of higher significance than the signal at a position of the logic cutting selector element in the signal path.

7. The digital circuit of claim 1 wherein the digital circuit is configured to be fully or partially used for an arithmetic computation, and is further configured to compute with reduced precision when the alternate signal path is substituted to the signal path by the logic cutting selector element compared to when the signal path is selected by the logic cutting selector element.

8. The digital circuit of claim 1 wherein the digital circuit is part of a mantissa computational circuit of a Floating-Point Unit, and is further configured to compute the mantissa with reduced precision when the alternate signal path is substituted to the signal path by the logic cutting selector element compared to when the signal path is selected by the logic cutting selector element.

9. The digital circuit of claim 1 further comprising a logic enabling element configured to either leave the logic cutting selector element switch in accordance with at least the cut-back signal, or to force the logic cutting selector element to select the signal path or the alternate path according to an enabling signal.

10. A method for optimizing a digital circuit, the method comprising:
transforming a digital circuit to improve a digital circuit implementation, by transforming at least one signal path of the digital circuit into a false path, hence co-designing the digital circuit behavior and the digital circuit implementation.

11. The method of claim 10 wherein the transforming of the digital circuit further comprises:
selecting the signal path, the signal path comprising at least 2 logic instances;
transforming the signal path into a false path, whereby the transforming comprises:
a logic monitoring of the digital circuit, to output a cut-back signal in case a determined risk of a full activation of the signal path is detected in the monitoring; and
a logic cutting being configured to be triggered by at least the cut-back signal to prevent the full activation of the signal path, the logic cutting being configured to switch, the switching either maintaining the signal path itself, or preventing the full activation of the signal path by substituting it for an alternate signal path, thereby inducing the false path.

12. The method of claim 11 wherein the alternate signal path is faster than the signal path.

13. The method of claim 11 further comprising:
prior to selecting the signal path, obtaining data about arrival times for at least one signal path in the digital circuit, the at least one signal path comprising at least 2 logic instances;
the signal path is selected among the at least one signal path based on its arrival time.

14. The method of claim 11 further comprising:
prior to selecting the signal path, obtaining data about the behavioral specifications of the digital circuit;
the signal path is selected among the at least one signal path based on the behavioral specifications.

15. The method of claim 11 further comprising:
prior to selecting the signal path, obtaining data about the accuracy specifications of the digital circuit;
the signal path is selected among the at least one signal path based on the accuracy specifications.

16. The method of claim 11 further comprising:
obtaining data about arrival times of the selected signal path;
the transforming of the signal path into a false path is based on arrival times.

17. The method of claim 10 further comprising:
obtaining data about the behavioral specifications of the digital circuit;
the transforming of the signal path into a false path is based on the behavioral specifications.

18. The method of claim 10 further comprising:
obtaining data about the accuracy specifications of the digital circuit;
the transforming of the signal path into a false path is based on the accuracy specifications.

19. The method of claim 11 wherein the logic cutting comprises a multiplexor configured to switch at least between the signal path and the alternate signal path.

20. The method of claim 11 wherein the logic cutting comprises a logic gate configured to cut the signal path by substituting it for a static value.

21. The method of claim 11 wherein the logic cutting comprises a storage element.

22. The method of claim 11 wherein the logic monitoring comprises a storage element.

23. The method of claim 10 further comprising:
simulating the behavioral alteration induced by the generated false path.

24. The method of claim 10 further comprising writing new circuit timing information, comprising at least one of timing constraints and timing exceptions induced by the generated false path.

25. The method of claim 10 further comprising using additional circuit timing information.

26. The method of claim 10 further comprising synthesizing the digital circuits using additional timing constraints and timing exceptions induced by the generated false path.

27. The method of claim 10 further comprising writing new circuit behavioral information, comprising the behavioral alteration induced by the generated false path.

28. The method of claim 10 further comprising using additional circuit behavioral information.

29. The method of claim 10 further comprising synthesizing the digital circuits using the additional circuit behavioral information induced by the generated false path.

30. The method of claim 11 wherein the digital circuit is fully or partially used for an arithmetic computation, and is further configured to compute with reduced accuracy when the alternate signal path is selected by the logic cutting selector compared to when the signal path is selected by the logic cutting selector.

31. The method of claim 11 wherein the digital circuit is part of the mantissa computational circuit of a Floating-Point Unit, and is further configured to compute the mantissa with reduced precision when the alternate signal path is selected by the logic cutting selector compared to when the signal path is selected by the logic cutting selector.

32. The method of claim 11 further comprising:
inserting a logic enabling element configured to either leave the logic cutting switch in accordance with at least the cut-back signal, or to force the logic cutting to select the signal path or the alternate path according to an enabling signal.

33. A non-transitory computer readable medium, the computer readable medium having computer readable instruction code recorded thereon, the instruction code configured to perform a method when executed on a hardware computer, the method comprising the steps of:
transforming a digital circuit to improve a digital circuit implementation, by transforming at least one signal path of the digital circuit into a false path, hence co-designing the digital circuit behavior and the digital circuit implementation.

34. The non-transitory computer readable medium of claim 33 wherein the method further includes:
selecting the signal path, the signal path comprising at least 2 logic instances; and
transforming the signal path into a false path, whereby the transforming comprises,
a logic monitoring of the digital circuit, to output a cut-back signal in case a determined risk of a full activation of the signal path is detected in the monitoring; and
a logic cutting being configured to be triggered by at least the cut-back signal to prevent the full activation of the signal path, the logic cutting being configured to switch, the switching either maintaining the signal path itself, or preventing the full activation of the signal path by substituting it for an alternate signal path, thereby inducing the false path.

35. The non-transitory computer readable medium of claim 34, wherein the alternate signal path is faster than the signal path.

36. The non-transitory computer readable medium of claim 34, the method further comprising:
prior to selecting the signal path, obtaining data about arrival times for at least one signal path in the digital circuit, the at least one signal path comprising at least 2 logic instances,
wherein the signal path is selected among the at least one signal path based on its arrival time.

37. The non-transitory computer readable medium of claim 34, the method further comprising:
prior to selecting the signal path, obtaining data about the behavioral specifications of the digital circuit;
the signal path is selected among the at least one signal path based on the behavioral specifications.

38. The non-transitory computer readable medium of claim 34, the method further comprising:
prior to selecting the signal path, obtaining data about the accuracy specifications of the digital circuit;
the signal path is selected among the at least one signal path based on the accuracy specifications.

39. The non-transitory computer readable medium of claim 34, the method further comprising:
obtaining data about arrival times of the selected signal path;
the transforming of the signal path into a false path is based on arrival times.

40. The non-transitory computer readable medium of claim 34, the method further comprising:
obtaining data about the behavioral specifications of the digital circuit;
the transforming of the signal path into a false path is based on the behavioral specifications.

41. The non-transitory computer readable medium of claim 34, the method further comprising:
obtaining data about the accuracy specifications of the digital circuit,
wherein the transforming of the signal path into a false path is based on the accuracy specifications.

42. The non-transitory computer readable medium of claim 34, wherein the logic cutting comprises a multiplexor configured to switch at least between the signal path and the alternate signal path.

43. The non-transitory computer readable medium of claim 34, wherein the logic cutting comprises a logic gate configured to cut the signal path by substituting it for a static value.

44. The non-transitory computer readable medium of claim 34, wherein the logic cutting comprises a storage element.

45. The non-transitory computer readable medium of claim 34, wherein the logic monitoring includes a storage element.

46. The non-transitory computer readable medium of claim 34, the method further comprising:
simulating the behavioral alteration induced by the generated false path.

47. The non-transitory computer readable medium of claim 34, the method further comprising:
writing new circuit timing information, comprising at least one of timing constraints and timing exceptions induced by the generated false path.

48. The non-transitory computer readable medium of claim 33, the method further comprising:
using additional circuit timing information.

49. The non-transitory computer readable medium of claim 33, the method further comprising:
synthesizing the digital circuits using additional timing constraints and timing exceptions induced by the generated false path.

50. The non-transitory computer readable medium of claim 33, the method further comprising:
writing new circuit behavioral information, comprising the behavioral alteration induced by the generated false path.

51. The non-transitory computer readable medium of claim 33, the method further comprising:
using additional circuit behavioral information.

52. The non-transitory computer readable medium of claim 33, the method further comprising:
synthesizing the digital circuits using the additional circuit behavioral information induced by the generated false path.

53. The non-transitory computer readable medium of claim 34, wherein the digital circuit is fully or partially used for an arithmetic computation, and is further configured to compute with reduced accuracy when the alternate signal path is selected by the logic cutting selector compared to when the signal path is selected by the logic cutting selector.

54. The non-transitory computer readable medium of claim 34, wherein the digital circuit is part of the mantissa computational circuit of a Floating-Point Unit, and is further configured to compute the mantissa with reduced precision when the alternate signal path is selected by the logic cutting selector compared to when the signal path is selected by the logic cutting selector.

55. The non-transitory computer readable medium of claim 34, the method further comprising:
inserting a logic enabling element configured to either leave the logic cutting switch in accordance with at least the cut-back signal, or to force the logic cutting to select the signal path or the alternate path according to an enabling signal.
